(19) United States
(12) Patent Application Publication
(10) Pub. No.: US 2004/0149323 A1
(43) Pub. Date: Aug. 5, 2004

(54) Continuous pickling method and continuous pickling apparatus

(76) Inventors: Kouichi Takeuchi, Tokyo (JP); Toshihiko Nonaka, Katori-gun (JP); Takeo Kataoka, Kashima-shi (JP)

Correspondence Address: CLARK & BRODY, 1750 K STREET NW, SUITE 600, WASHINGTON, DC, 20006, US

(21) Appl. No.: 10/691,667

(22) Filed: Oct. 24, 2003

Related U.S. Application Data
(63) Continuation of application No. PCT/JP02/04137, filed on Apr. 25, 2002.

(30) Foreign Application Priority Data
Apr. 27, 2002 (JP) 2001-132264

(51) Int. Cl. B08B 3/00; B08B 6/00

(52) U.S. Cl. 134/94.1; 134/201

(57) ABSTRACT

A predicted value of acid consumption during pickling with a pickling solution in each of a third tank 11c and a final tank 11d of a continuous pickling apparatus 10 is calculated by a pickling line control unit 24, and based on the calculated predicted value, the amount of acid solution to be supplied to each of the third tank 11c and the final tank 11d is determined, and acid solution is supplied from an acid solution supply system 12. The acid concentration of the pickling solution in each of the third tank 11c and the final tank 11d to which acid solution is supplied is continuously measured by continuous acid concentration measuring devices 13c and 13d, and based on the continuously measured value of the measured acid concentration, acid solution is supplied from the pickling solution supply system 12 to the third tank 11c and the final tank 11d so that the concentration of the pickling solution in each of the third tank 11c and the final tank 11d matches a target value. As a result, while the acid concentration of the pickling solution in the final pickling tank is suppressed to at most 12%, the acid concentration of the pickling solution in the other pickling tanks can be raised to a desired value.

### TECHNICAL FIELD

This invention relates to a continuous pickling method and a continuous pickling apparatus. More specifically, this invention relates to a continuous pickling method and a continuous pickling apparatus for removing scale present on the surface of steel strip, for example, at the completion of hot rolling.

### BACKGROUND ART

As is well known, a hot rolled steel strip has scale in the form of oxides on the surface thereof. The scale is typically removed by pickling, which is carried out by continuously dipping the steel strip in a pickling solution which is a solution of hydrochloric acid or similar acid. The pickling treatment is normally carried out using a continuous pickling apparatus having about three to five pickling tanks.

FIG. 6 is an explanatory view schematically showing a continuous pickling apparatus 1 having four pickling tanks 2a-2d. As shown in this figure, pickling is carried out by continuously passing a steel strip 3 in succession through a first tank 2a, a second tank 2b, a third tank 2c, and a fourth tank (final tank) 2d of the continuous pickling apparatus 1. The pickling solution in each of the pickling tanks 2a-2d gradually decreases by reaction with the steel strip 3 or due to entrainment by the steel strip 3. Therefore, in this continuous pickling apparatus 1, an acid solution is supplied to the final tank 2d from an acid solution supply unit 4. The acid solution which is supplied is successively transported from a pickling tank on the downstream side to an adjacent pickling tank on the upstream side by acid solution transporting piping 5a-5c provided between each of the adjacent pickling tanks 2a-2d. The pickling solution which overflows from the first tank 2a is passed to a recovery unit 6, where it is recovered and reused.

Thus, in the continuous pickling apparatus 1, a pickling solution is circulated between each of the pickling tanks 2a-2d, and the acid concentration of the pickling solution is different in each of the pickling tanks 2a-2d. For example, the acid concentration in the final tank 2d is approximately 12% (in the specification, unless otherwise specified, “%” means “weight percent”), whereas it is approximately 3% in the first tank 2a. The acid concentrations in the third tank 2c and the second tank 2b are concentrations between the acid concentrations in the final tank 2d and the first tank 2a.

In the continuous pickling apparatus 1, in order to determine the amount of acid solution to be supplied to the final tank 2d, it is necessary to measure the actual acid concentration of the pickling solution in at least the final tank 2d. The acid concentration can be measured by using a known titration type analyzing instrument (such as that sold under the trade name “Titrator”), or by a method in which the acid concentration is continuously measured based on the electrical conductivity, density, and temperature of the solution.

When using a titration type analyzing instrument, in order to compensate for the fact that the acid concentration of a pickling solution cannot be measured in a short period of time, an invention is disclosed in JP P57-174473A (1982), for example, in which the amount of acid solution to be supplied is determined by calculations based on the dimensions and the material or the like of a steel strip without measuring the acid concentration of a pickling solution. In JP P07-54175A (1995), an invention is disclosed in which the amount of acid solution to be supplied is determined by calculations based on the measured value of the thickness of a steel sheet before and after pickling without measuring the acid concentration of a pickling solution. According to these prior art inventions, the acid concentration of a pickling solution in a pickling tank to which an acid solution is supplied (the final tank 2d in the case of the continuous pickling apparatus 1 of FIG. 6) is controlled to a target value, although the control accuracy is as low as ±3-5%.

In the above-described prior art, since an acid solution is only supplied to one tank, it is not easy to increase the acid concentration of the pickling solution in the pickling tanks other than the pickling tank to which the acid solution is supplied. As a result, it is not possible to increase the productivity of the pickling process by increasing the pickling speed in a pickling process using the continuous pickling apparatus 1. Namely, in order to increase the pickling speed of the continuous pickling apparatus 1, it is necessary to increase the overall acid concentration of pickling solution in each of the pickling tanks 2a-2d by increasing the supply of the acid solution to the final tank 2d, which is the tank to which the acid solution is supplied. However, if the acid concentration of the pickling solution in the final tank 2d exceeds approximately 12%, the pickling solution has an increased vapor pressure of hydrochloric acid. Therefore, the consumption of hydrochloric acid due to evaporation in the final tank 2d increases, and the cost of the pickling solution markedly increases. Accordingly, the acid concentration of the pickling solution in each of the pickling tanks 2a-2c other than the final tank 2d cannot be controlled to a target value which is sufficiently high to increase the speed of pickling.

In the invention disclosed in JP P07-54175A, in order to control the acid supply, it is necessary to measure the thickness of a steel sheet before and after a pickling tank. Since the thickness of scale on the surface of a steel sheet is on the order of 3-12 μm, in order to quantify the scale thickness, it is necessary to measure the thickness of the steel sheet with an accuracy of a micrometer. However, in view of the fact that the thickness of a steel sheet can vary by a micrometer, it is extremely difficult to measure the thickness of a continuously traveling hot rolled steel sheet with an accuracy of a micrometer.

In JP P09-125270A (1997), an invention is disclosed which uses pickling tanks and a circulating tank and in which the acid concentration in the pickling tanks is controlled by supplying, in principle, only an acid when the analyzed value of the acid concentration is lower than a targeted lower limit, or only water when the analyzed value of the acid concentration is higher than a targeted upper limit. However, it is essentially based on feedback control, and hence the responsiveness of control is poor. Therefore, that invention cannot minimize variations in acid concentration.

JP P10-306391A (1998) discloses an invention in which quantities of state (state functions) for a steel plate relating to the thickness, the width, and the amount of scale of a steel strip, and quantities of state for plant operation relating to the concentration, the amount, and the temperature of acid supplied to a pickling tank, the line speed, and the temperature of the strip immediately before entry into the pickling tank are monitored, descaling rates at an arbitrary number of portions within the pickling tank are determined using these values, and the quantities of state for optimal operation of the plant are determined based on the values for descaling rates. In that invention, the descaling phenomenon during pickling is anathematized to control the supply of an acid. However, in actual pickling, particularly with a steel plate which forms a large amount of wuestite (FeO), as is encountered in a strip coiled at a high temperature, part of the scale peels off during pickling as descaling proceeds. Therefore, it is extremely difficult to quantify the amount of peeled-off scale in each of a plurality of divided regions in a pickling tank. Thus, that invention has poor control responsiveness, and it cannot minimize variations in acid concentration.

The present inventors disclosed an invention relating to a continuous pickling apparatus in JP P2000-297390A. That continuous pickling apparatus includes the combination of at least two pickling tanks of a plurality of pickling tanks which make up the continuous pickling apparatus, an acid solution supply system which supplies an acid solution to each of the at least two pickling tanks, continuous acid concentration measuring devices which continuously measure the acid concentration of pickling solution in the at least two pickling tanks, and a control unit which calculates a predicted value of acid consumption during pickling of the pickling solution in the at least two pickling tanks based on the pickling conditions during pickling, determines the amount of acid solution to be supplied based on the calculated predicted value and outputs an acid solution supply signal to the acid solution supply system, and which also outputs an acid solution supply signal to the acid solution supply system based on a continuously measured value of the acid concentration which is output from the continuous acid concentration measuring devices after the acid solution is supplied to the at least two pickling tanks from the acid solution supply system so that the acid concentration of pickling solution in each of the at least two pickling tanks matches a target value.

The continuous pickling apparatus according to that proposal calculates a predicted value of acid consumption during pickling of the pickling solution in at least two pickling tanks of a plurality of pickling tanks making up the continuous pickling apparatus based on the pickling conditions during pickling, determines the amount of acid solution to be supplied to each of the at least two pickling tanks based on the calculated predicted value and supplies an acid solution accordingly, continuously measures the acid concentration of pickling solution in each of the at least two pickling tanks which are supplied the acid solution, and controls the supply of acid solution to the at least two pickling tanks based on a continuously measured value of acid concentration so that the acid concentration of pickling solution in each of the at least two pickling tanks matches a target value.

That continuous pickling apparatus can increase the acid concentration of pickling solution in each pickling tank and make it approach a target value while minimizing the amount of evaporation of the pickling solution from each pickling tank. Therefore, with that apparatus, using existing continuous pickling equipment, the productivity of pickling can be increased with minimized alterations of the continuous pickling equipment.

### DISCLOSURE OF THE INVENTION

This invention further develops and improves the above-described continuous pickling apparatus and continuous pickling method.

An object of this invention is to provide a continuous pickling method and a continuous pickling apparatus which can increase the acid concentration of a pickling solution in each pickling tank so that it approaches a desired value while minimizing evaporation of the pickling solution from a pickling tank to which an acid solution is supplied, thereby making it possible increase the productivity of pickling. Another object of this invention is to provide such a continuous pickling method and continuous pickling apparatus with minimized alterations of existing continuous pickling equipment.

The present invention is a continuous pickling method comprising performing pickling of a traveling steel strip while supplying an acid solution to at least two pickling tanks of a plurality of pickling tanks making up a continuous pickling apparatus, characterized in that a total amount of acid solution to be supplied is determined based on the scale thickness formed on the steel strip and the width and the traveling speed of the steel strip, and a distribution ratio of the acid solution supply to the at least two pickling tanks is determined based on a pickling pattern of the steel strip and the traveling speed of the steel strip, thereby controlling the amount of acid solution which is supplied to each of the at least two pickling tanks.

In the continuous pickling method according to the present invention, it is exemplified that a distribution ratio of the acid solution supply is determined using a value selected from a plurality of predetermined set values.

In the continuous pickling method according to the present invention, it is exemplified that a value selected from a plurality of predetermined set values based on the steel type of the steel strip is used as the value of scale thickness.

Here, “based on the steel type” means that the set value of the scale thickness is determined based on the steel composition and the coiling temperature after hot rolling, which have a large influence on the scale thickness. Accordingly, this means that even with two steel strips having the same steel composition, if the coiling conditions differ, they are defined as different steel types. Steel types may be classified into a plurality of groups so that the steel types in each group have similar values of scale thickness, and each of the classified groups may be represented by a single set value.

There is no particular limit on the number of set values for the above-described scale thickness and distribution ratio. In accordance with the type of steel type which is treated by the pickling apparatus, the number of scale thicknesses may be suitably set to one or more, and the number of distribution ratio groups may be suitably set to one or more.

In the continuous pickling method according to the present invention, it is exemplified that the distribution ratio of the acid solution supply is determined using a value selected from a plurality of predetermined set values based on the traveling speed of the steel strip.

In the continuous pickling method according to the present invention, it is exemplified that a correction value based on the difference between the measured value and a set value of acid concentration of the pickling solution in each of the at least two pickling tanks is added to the acid solution supply.

In the continuous pickling method according to the present invention, it is exemplified that predetermined set values for the scale thickness and/or the distribution ratio are corrected and set based on the correction value for control which is added to the acid solution supply.

In the continuous pickling method according to the present invention, it is exemplified that the at least two pickling tanks include at least a final pickling tank.

According to another aspect, the present invention is a continuous pickling apparatus for performing pickling of a traveling steel strip while supplying an acid solution to at least two pickling tanks of a plurality of pickling tanks making up the continuous pickling apparatus, characterized in that a total amount of acid solution to be supplied is determined based on the scale thickness of the steel strip and the width and the traveling speed of the steel strip, and a distribution ratio of the acid solution supply to the at least two pickling tanks is determined based on the pickling pattern of the steel strip and the traveling speed of the steel strip, thereby controlling the amount of acid solution which is supplied to each of the at least two pickling tanks.

In the continuous pickling apparatus according to the present invention, it is exemplified that the distribution ratio of the acid solution supply is determined using a value selected from a plurality of predetermined set values.

In the continuous pickling apparatus according to the present invention, it is exemplified that a value selected from a plurality of predetermined set values based on the steel type of the steel strip is used as the value of scale thickness.

In the continuous pickling apparatus according to the present invention, it is exemplified that the distribution ratio of the acid solution supply is determined using a value selected from a plurality of predetermined set values based on the traveling speed of the steel strip.

In the continuous pickling apparatus according to the present invention, it is exemplified that a correction value based on the deviation from a set value of the measured value of acid concentration of the pickling solution in each of the at least two pickling tanks is added to the supply of the acid solution.

In the continuous pickling apparatus according to the present invention, it is exemplified that a predetermined set value for the scale thickness and/or the distribution ratio is corrected and set based on the correction value for control which is added to the acid solution supply.

Furthermore, in the continuous pickling apparatus according to the present invention, it is exemplified that the at least two pickling tanks include at least a final pickling tank.

In the continuous pickling apparatus according to the present invention, the continuous pickling apparatus is preferably a continuous pickling apparatus of the type in which a pickling solution in a pickling tank on a downstream side successively overflows to an adjacent pickling tank on the upstream side, or a continuous pickling apparatus of the type in which a pickling solution in a pickling tank on a downstream side is successively transported to an adjacent pickling tank on the upstream side.

In the continuous pickling apparatus according to the present invention, each of at least two pickling tanks is preferably provided with an acid concentration measuring device to perform measurements.

### BRIEF DESCRIPTION OF THE DRAWINGS

FIG. 1 is an explanatory view schematically showing the structure of a continuous pickling apparatus described below as an embodiment.

FIG. 2 is an explanatory diagram which shows the third tank and the final tank of this embodiment of a continuous pickling apparatus and schematically shows the control flow thereof.

FIG. 3 is a graph showing pickling patterns.

FIG. 4 is a graph showing an example of the relationship between pickling time and weight loss by pickling.

FIG. 5 is a block diagram showing the control flow of an embodiment of the present invention.

FIG. 6 is an explanatory view schematically showing a conventional continuous pickling apparatus having four pickling tanks.

### DESCRIPTION OF EMBODIMENT OF THE INVENTION

Now, an embodiment of a continuous pickling method and a continuous pickling apparatus according to the present invention will be described in detail while referring to the attached drawings. The following description of an embodiment is given by taking an example in which the pickling solution is a hydrochloric acid solution and in which a continuous acid concentration measuring device 13 proposed by the present inventors in JP P2000-313978A and JP P2000-313979A is used. When carrying out the present invention, acid concentration measurement is preferably conducted using this continuous acid concentration measuring device 13, but the present invention is not restricted to this mode, and it may be carried out using an intermittently measuring device such as a titration type or the like.

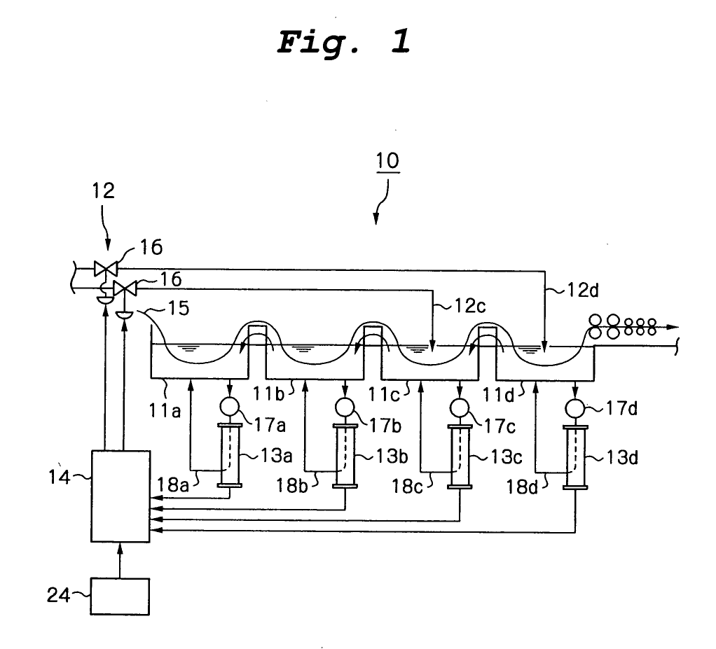

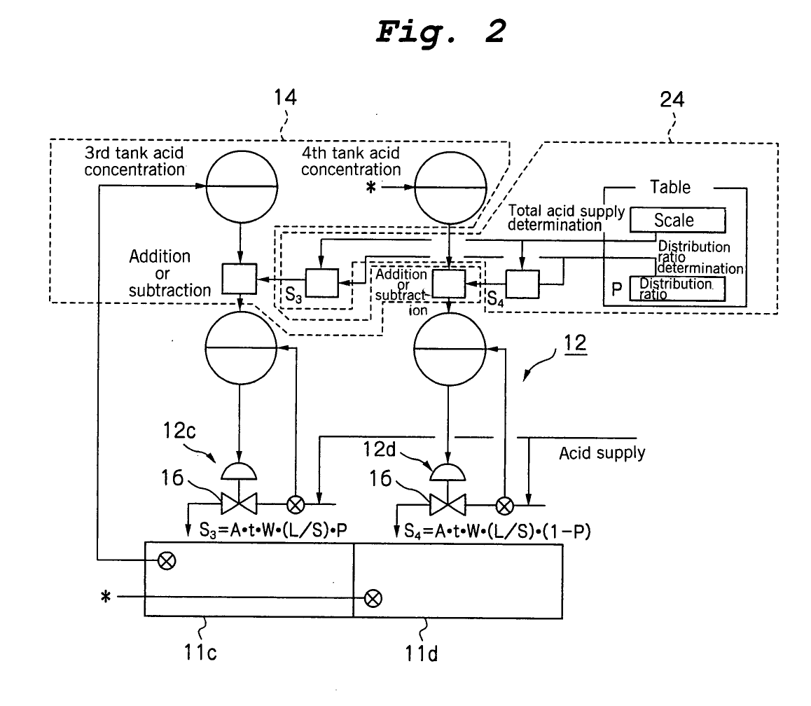

FIG. 1 is an explanatory view schematically illustrating the structure of an embodiment of a continuous pickling apparatus 10. FIG. 2 is a explanatory view which shows the third tank 11c and the final tank 11d of the continuous pickling apparatus 10 and schematically shows the control flow. As shown in FIG. 1 and FIG. 2, the continuous pickling apparatus 10 has pickling tanks 11a-11d, an acid solution supply system 12, continuous acid concentration measuring devices 13c and 13d, a feedback control unit 14, and a pickling line control unit 24. Below, these constituent elements will be described individually.

[Pickling Tanks 11a-11d]

The continuous pickling apparatus 10 has four pickling tanks 11a-11d. Pickling tank 11a is a first tank, pickling tank 11b is a second tank, pickling tank 11c is a third tank, and pickling tank 11d is a final tank.

A steel strip 15 which is pickled is dipped in succession in the pickling solution in each of the pickling tanks 11a-11d in the order of the first tank 11a, the second tank 11b, the third tank 11c, and the final tank 11d. The steel strip 15 which leaves the final tank 11d is passed to subsequent processes.

In the continuous pickling apparatus 10, the pickling solution which is in a pickling tank on the downstream side overflows in succession to the adjacent pickling tank on the upstream side. Thus, the pickling solution in the final pickling tank 11d overflows to the third pickling tank 11c, the pickling solution in the third pickling tank 11c overflows to the second pickling tank 11b, and the pickling solution in the second tank 11b overflows to the first tank 11a. The pickling solution which overflows from the first tank 11a is passed to a recovery unit, which is not shown, where it is recovered and then reused.

In the illustrated embodiment, the pickling tanks 11a-11d are constituted as described above.

[Acid Solution Supply System 12]

This embodiment of a continuous pickling apparatus 10 has an acid solution supply system 12. The acid solution supply system 12 of this embodiment is constituted by a third tank acid solution supply unit 12c which supplies an acid solution to the third tank 11c, and a final tank acid solution supply unit 12d which supplies an acid solution to the final tank 11d. The third tank acid solution supply unit 12c and the final tank acid solution supply unit 12d are each connected to an acid solution supply source, which is not shown, through flow control valves 16. The flow control valves 16 which are provided on both the third tank acid solution supply unit 12c and the final tank acid solution supply unit 12d are each connected to a feedback control unit 14 to be described below, and the opening of the valve is controlled by an acid solution supply signal which is output from the feedback control unit 14.

It is more preferred that the opening of the flow control valves 16 be controlled based on feedback of a signal from flow meters provided on the piping. The amount of the acid solution to be supplied from the third tank acid solution supply unit 12c to the third tank 11c and the amount of the acid solution to be supplied from the final tank acid solution supply unit 12d to the final tank 11d are individually controlled by these flow control valves.

In this embodiment, an acid solution is supplied to the third tank 11c and the final tank 11d. However, in a different embodiment, it is possible to provide an acid solution supply unit like the third tank acid solution supply unit 12c and the final tank acid solution supply unit 12d on the second tank 11b and further on the first tank 11a and to individually supply an acid solution thereto.

In the illustrated embodiment, the acid solution supply system 12 is constituted as described above.

[Continuous Acid Concentration Measuring Devices 13c and 13d]

In this embodiment, a continuous acid concentration measuring device 13c is provided on the third tank 11c, and a continuous acid concentration measuring device 13d is provided on the final tank 11d. The continuous acid concentration measuring device 13c and the continuous acid concentration measuring device 13d are preferably the same as each other. From the standpoint of response speed and accuracy, the acid concentration meter disclosed in JP P2000-313978A or JP P2000-313979A is preferably used as these continuous acid concentration measuring devices. The details thereof are disclosed in the above-numbered Japanese patent publications, so an explanation thereof will be omitted.

In this embodiment, continuous acid concentration measuring devices 13c and 13d are provided on the third tank 11c and the final tank 11d, respectively, but the invention is not limited to this embodiment, and as shown in FIG. 1, a continuous acid concentration measuring device 13b may also be provided on the second tank 11b, and if necessary, a continuous acid concentration measuring device 13a may further be provided on the first tank 11a, and the output signals therefrom may also be input to the feedback control unit 14.

[Pickling Line Control Unit 24]

This embodiment of a continuous pickling apparatus 10 has a pickling line control unit 24. The pickling line control unit 24 calculates the amount of acid supply to the pickling solution in the third tank 11c during pickling and the amount of acid supply to the pickling solution in the final tank 11d during pickling based on predetermined set values for the thickness of the scale present on the surface of the steel strip 15 to be pickled and for the distribution ratio of acid solution supply to at least two of the pickling tanks.

Calculation of the acid consumption in each of the third tank 11c and the final tank 11d is carried out based on the pickling conditions during pickling including the material and dimensions of the steel strip 15, the traveling speed of the strip, the composition and the temperature of the acid solution, the dimensions of each tank, and the like which are input to the pickling line control unit 24, but there is no restriction to any particular means for performing the calculation. Calculation is performed based at least on the thickness of the scale present on the surface of the steel strip 15 at the time of pickling and the distribution ratios of acid solution supply to at least two pickling tanks.

Thus, a scale layer having a thickness on the order of 3-12 μm is present on the surface of the steel strip 15 at the time of pickling, and the acid consumption per unit time in each pickling tank during pickling is roughly proportional to this scale thickness. Therefore, the total amount S of acid consumption can be determined based on the thickness t of the scale layer on the surface of the steel strip 15, the width W of the strip, the traveling speed L/S of the steel strip 15, and a conversion coefficient A as follows:

S=A·t·W·(L/S).

As illustrated by the graph in FIG. 3, when pickling is carried out at the same traveling speed of a steel strip, pickling can be roughly classified according to three patterns, i.e. a pickling pattern (referred to in the specification as simply a “pattern”) 1 shown by a solid line, a pattern 2 shown by a dashed line, and a pattern 3 shown by a one-dot chain line. This example shows the case in which the patterns of the progress of pickling are categorized into three types in accordance with the position of the steel strip 15 at the completion of pickling. As an example, the case will be considered in which a steel strip categorized as pattern 1 in the graph in FIG. 3 is compared with a steel strip categorized as pattern 3 therein. In this case, the position at the completion of pickling for the steel strip categorized as pattern 3 is on the downstream side of that for the steel strip classified as pattern 1, so the acid consumption in the fourth tank 11d increases in pattern 3. Therefore, when pickling a steel strip categorized as pattern 3, it is necessary for the set value of the distribution ratio to be different from in the case in which a steel strip categorized as pattern 1 is pickled. Namely, it is necessary to classify the pattern of pickling based on the traveling speed of the steel strip 15 to perform optimization. The number of classified patterns can be suitably set to more than one pattern based on the type of steel treated by the pickling apparatus. The pickling pattern varies depending on the scale thickness and the pickling speed under conditions of a given traveling speed.

For example, for steel types having the same pickling speed, when the thickness of scale is larger, the position at the completion of pickling shifts toward the downstream side, and pattern 3 results. On the other hand, when the scale thickness is smaller, it shifts toward the upstream side, and pattern 1 results.

For steel types having the same scale thickness, when the pickling speed is slower, the position at the completion of pickling shifts toward the downstream side, and pattern 3 results. On the other hand, when the pickling speed is faster, it shifts toward the upstream side and pattern 1 results.

The pickling speed used herein means the weight loss by pickling per unit time, and it varies depending on the scale composition, which depends upon the steel composition and the manufacturing conditions of the steel strip, the conditions of the preceding processing of the steel strip such as the number of cracks formed in the scale due to rolling and the like, and pickling conditions such as the acid concentration, the pickling temperature, the flow of the acid solution, and the like.

Thus, when the acid solution is supplied to the third tank 11c and the final tank 11d, the total acid consumption S can be distributed among each tank using a distribution ratio determined based on the traveling speed of the steel strip 15 in accordance with the type of steel. If the distribution coefficient (distribution ratio) is taken as P (0≦P≦1), then the distributed amounts S₃ and S₄ of acid to the third tank 11c and the final tank 11d, are respectively S₃=S·P and S₄=S·(1−P).

The amount and the composition of scale present on the surface of the steel strip 15 also varies depending on the coiling temperature of the steel strip 15. The coiling temperature varies due to lack of uniformity in operating conditions as well as variations in the cooling speed of the hot rolled steel strip due to changing of the seasons. Therefore, the amount and the composition of the scale varies particularly along the edge portions of the steel strip 15.

Accordingly, when determining the thickness of the scale, it is preferable to take into consideration not only the steel composition of the steel strip 15 but also the coiling temperature of the steel strip 15.

Thus, the acid consumption in each of the third tank 11c and the final tank 11d varies depending on the amount of scale present on the surface of the steel strip 15 and the position at the completion of pickling (the pattern of progress of pickling). Therefore, regardless of how excellent the pickling model used to carry out feedforward control of the acid concentration, errors in the set value for the scale thickness and errors in the set value for the distribution ratio P based on the traveling speed inevitably take place. As a result, it is extremely difficult to make the controlled value in actual operation exactly match the actual value.

Therefore, in this embodiment, the supply of acid solution to each of the third tank 11c and the final tank 11d is controlled using not only feedforward control but by using feedback control together with feedforward control.

Namely, the pickling line control unit 24 supplies an acid solution from the third tank acid solution supply unit 12c to the third tank 11c and from the final tank acid solution supply unit 12d to the final tank 11d. The feedback control unit 14 adds an acid solution supply signal to the acid solution supply system 12 based on the deviation of the continuously measured value of the acid concentration in each tank which is output from the continuous acid concentration measuring devices 13c and 13d from the acid concentration target value for each tank, and it performs feedback control such that the acid concentration of the pickling solution in each of the third tank 11c and the final tank 11d matches the target value for the tank.

Thus, by performing feedback control superposed on feedforward control, an excess or insufficiency in the supply amount of the acid solution, which is a drawback of feedforward control, can be reduced to an extent that it is not a problem in practical applications. However, when feedforward control has a large error, the problem may develop that a long time is required until the acid concentration of the pickling solution is stabilized by feedback control. In order to prevent such a problem, in this embodiment, the set values (parameters) for feedforward control are set as close as possible to values for actual operation.

For example, if the decrease in the amount of scale (herein referred to as “weight loss by pickling”) per unit area is approximated by a linear equation with respect to time, the relationship between the pickling time and the weight loss by pickling has a proportional relationship. FIG. 4 is a graph showing one example of this relationship.

As shown in the graph of FIG. 4, the relationship between the pickling time and the weight loss by pickling is a linear relationship starting at the origin O. Namely, the weight loss by pickling m₁ at time t₁ when the steel strip passes the exit side of the first tank 11a, the weight loss by pickling m₂ at time t₂ when it passes the exit side of the second tank 11b, the weight loss by pickling m₃ at time t₃ when it passes the exit side of the third tank 11c, and the weight loss by pickling m₄ at time t₄ when it passes the exit side of the final tank 11d are all positioned on the same straight line, and the weight loss by pickling is constant after time t₄ when pickling is completed. The slope of this straight line indicates the pickling speed, and it is determined by the material of the steel strip 15 which is pickled and the pickling conditions (the temperature and the composition and the like of the pickling solution).

Accordingly, the acid consumption in each of the pickling tanks 11a-11d is found by multiplying the slope of the straight line of the graph in FIG. 4 by the dimensions (width) of the steel strip 15 and the traveling speed of the steel strip. The consumption of pickling solution in each of the pickling tanks 11a-11d can be calculated in this manner. If the relationship between the pickling time and the weight loss by pickling is not approximated by a straight line as in this embodiment but is approximated by an S-shaped curve close to the actual pickling curve as shown by the one-dot chain line in the graph of FIG. 4, the acid consumption in each of the pickling tanks 11a-11d can be calculated with higher accuracy.

Thus, the set value for the scale thickness can be calculated from the weight loss by pickling m₄ in the graph of FIG. 4, which is the weight loss at the time of completion of pickling. On the other hand, the distribution ratio P based on the traveling speed can be determined based on the ratio between the acid consumption in the third tank 11c to the final tank 11d. The distribution ratio P for pickling tanks 11c and 11d is calculated based on the values of weight loss (m₃−m₂) and (m₄−m₃) in these tanks in the graph of FIG. 4 as P=(m₃−m₂)/{(m₄−m₃)+(m₃−m₂)}. The distribution ratio P can also be found in the same manner using FIG. 3.

The relationship between the acid consumption and the traveling speed at this time is as described below. Namely, the horizontal axis (t₃−t₄) in the graph of FIG. 4 gives the lengths of time when the steel strip exits the pickling tanks 11c and 11d, respectively. Therefore, as the traveling speed becomes slower, the lengths of time become longer, the acid consumption in the fourth tank decreases, and when the length of time at the completion of pickling becomes smaller than time t₃, the acid consumption in the fourth tank 11d essentially becomes zero. Since a pickling inhibitor is added to a pickling solution, pickling does not appreciably proceed after the scale has been completely removed. In order to further improve the accuracy of control by the distribution ratio P which is determined in this manner, as useful means for this purpose, a test may be carried out using an actual pickling apparatus to adjust the set values, or the set values may be rewritten on-line employing learning control, which is one of the characteristics of the present invention.

Specifically, the set values for the thickness of scale present on the surface of a steel strip at the time of pickling and for the distribution ratio to the at least two pickling tanks, which are used in feedforward control, are corrected and reset based on the correction values of feedback control.

The control unit of this embodiment is constituted as described above.

Next, the conditions in which pickling of a steel strip 15 is carried out using this embodiment of a continuous pickling apparatus 10 having four pickling tanks 11a-11d, an acid solution supply system 12, continuous acid concentration measuring devices 13c and 13d, a feedback control unit 14, and a pickling line control unit 24 will be explained in order of time.

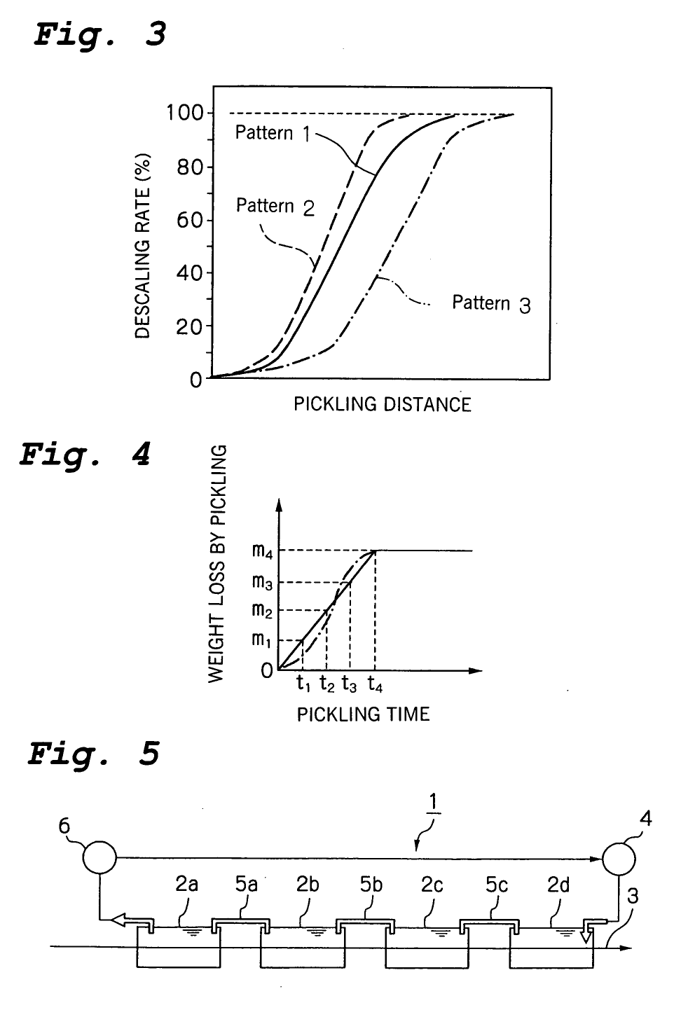

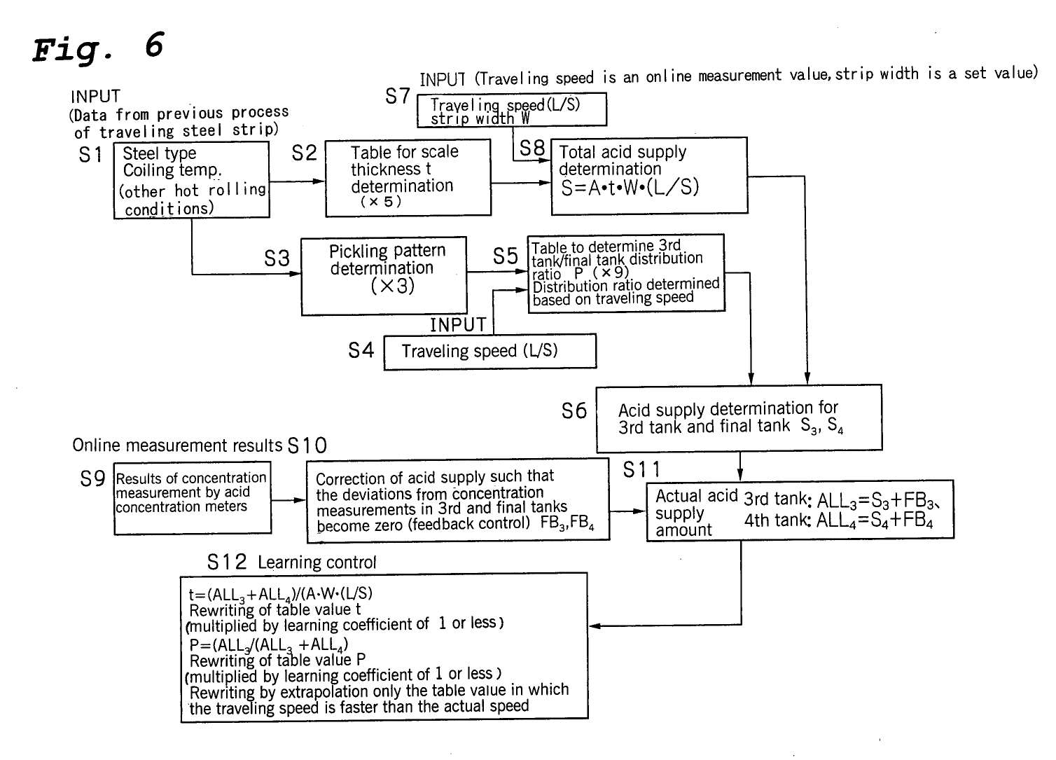

FIG. 5 is a block diagram showing the control flow of this embodiment. The following description will be made while referring to FIG. 5.

[Calculation of Acid Consumption]

Pickling of a steel strip 15 is carried out by the continuous pickling apparatus 10 shown in FIG. 1.

In S1 (“S” indicating Step) to S5 of FIG. 5, information on the traveling steel strip (the steel type, the width, the coiling temperature, and the like) and the line speed are input to the pickling line control unit 24, and the acid consumption of the pickling solution in each of the third tank 11c and the final tank 11d is calculated.

The calculated value includes an error with respect to the actual acid consumption. In this embodiment, as described below, this error can be reduced as much as possible by controlling the supply of the acid solution using a continuously measured value of the acid concentration.

[Supply of the Acid Solution Based on the Calculated Value]

Next, in S6 in FIG. 5, the amount of acid solution to be supplied to each of the third tank 11c and the final tank 11d is determined by the pickling line control unit 24 based on the calculated values of acid consumption of pickling solution in the third tank 11c and the final tank 11d.

At this time, as described earlier, the acid solution supply amounts S₃ and S₄ to the third tank 11c and the final tank 11d, respectively, are found in S6 as

S₃=A·t·W·(L/S)·P=S·P and S₄=A·t·W·(L/S)·(1−P)=S·(1−P)

using, as values in a predetermined table, the set value for the thickness t of the scale formed on the surface of the steel strip 15 at the time of pickling, which is determined in S2 of FIG. 5, and the set value for the distribution ratio P to pickling tanks 11c and 11d, which is determined in S5 of FIG. 5.

Thus, the “distribution ratio of the acid solution supply” as used herein means the ratio of distribution of the acid solution supply to the third tank relative to the total acid solution supply in the supply of the acid solution.

In S6, in order to determine the acid solution supply amounts S₃ and S₄ to the third tank 11c and the final tank 11d, respectively, the total acid supply S=A·t·W·(L/S) is found in S8 from the traveling speed (L/S) and the width W of the strip, which are input in S7.

Acid solution control signals are output from the pickling line control unit 24 to the flow control valves 16, 16 for the third tank acid solution supply system 12c and the final tank acid solution supply system 12d, respectively, and the supply amounts of acid solution which are determined are supplied to the third tank 11c and the final tank 11d.

[Continuous Measurement of Acid Concentration]

After the determined supply amounts S₃ and S₄ of acid solution are supplied to the third tank 11c and the final tank 11d, respectively, in the above-described manner, in S9 of FIG. 5, the acid concentration of the pickling solution in the third tank 11c is continuously measured by an acid concentration measuring device 13c, and the acid concentration of the pickling solution in the final tank 11d is continuously measured by an acid concentration measuring device 13d. These continuously measured values are passed to the feedback control unit 14.

[Supply of Acid Solution Based on the Results of Continuous Measurement]

In S10 of FIG. 5, in the feedback control unit 14, the deviation of these continuously measured values from the respective target values for the acid concentration of the pickling solution in the third tank 11c and the final tank 11d is determined. Then, the supply amounts S₃ and S₄ of the acid solution for the third tank 11c and the final tank 11d, respectively, are determined as S₃+FB₃ and S₄+FB₄ by addition or subtraction of the acid solution supply signals from the feedback control unit 14 to the flow control valves 16, 16 for the third tank acid solution supply system 12c and the final tank acid solution supply system 12d so that this deviation becomes zero.

At this time, in S12 of FIG. 5, learning control is carried out in which the set value of the thickness t of the scale and the set value of the distribution ratio P between pickling tanks 11c and 11d are corrected and reset to t′ and P′, respectively, based on the results of feedback control.

Therefore, the errors in the predicted calculation results S₃ and S₄ for the acid solution supply to the third tank 11c and the final tank 11d, respectively, are almost completely compensated for. As a result, in this embodiment, the acid concentration of the pickling solution present not only in the final tank 11d but also in the third tank 11c can be made to rapidly and accurately approach their respective target values.

In this embodiment, an acid solution is supplied not only to the final tank 11d but also to the third tank 11c in order to increase the acid concentration of the pickling solution contained in each of the fourth tank 11d and the third tank 11c so as to make it approach a target value. Accordingly, in this embodiment in which a fourth tank is the final tank 11d, an acid solution is supplied to the final tank 11d and the third tank 11c, but in the case of a continuous pickling apparatus in which a fifth tank is the final tank, it is preferable to supply an acid solution to the final tank and the third tank.

In this embodiment, the supply of an acid solution based on the results of continuous measurement is carried out not only with respect to the final tank 11d but also with respect to the third tank 11c. Therefore, the acid concentration of the pickling solution in the third tank 11c can be increased so as to approach a target value without increasing the acid concentration of the pickling solution in the final tank 11d above 12%. Accordingly, the acid concentration of the pickling solution in the third tank 11c can be increased to approach a target value while preventing evaporation of the pickling solution from the final tank 11d, thereby making it possible to perform pickling of a steel strip 15 in such a manner that each of the pickling tanks 11a-11d can exhibit an adequate pickling ability. Thus, in this embodiment, the overall productivity of the continuous pickling apparatus 10 can be markedly increased.

In addition, this embodiment can be implemented merely by providing continuous acid concentration measuring devices 13c and 13d in the vicinity of the third tank 11c and the final tank 11d of an existing continuous pickling apparatus, by sending the output signals from these continuous acid concentration measuring devices 13c and 13d to a feedback control unit 14, and by partially supplementing or modifying the software of the feedback control unit 14 and the pickling line control unit 24. Therefore, it can be carried out with minimal rebuilding of an existing continuous pickling equipment.

Thus, according to this embodiment, it is possible to achieve a reduction in rejection rate and an increase in productivity without an extensive modification of conventional production equipment.

### EXAMPLES

This invention will be described more specifically while referring to examples.

Pickling of a steel strip 15 was carried out for 24 hours using the continuous pickling apparatus 1 described with respect to FIGS. 1-5 (capacity of each pickling tank 13a-13d: 60 m³, temperature of pickling solution: 90° C.) by the continuous pickling method according to the present invention and by a comparative example which was a continuous pickling method using only feedback control. In pickling using this type of continuous pickling apparatus, normally, the acid concentration changes at a rate of approximately several percent per hour, so this experiment is a sufficient length of time in order to evaluate the utility of the present invention.

In this example, the types of steel produced (having different materials and coiling temperatures) were classified into five types according to scale thickness and also into three types according to pickling pattern to carry out baseline experiments for each class. Based on the experimental results, a table having set values for distribution ratio was prepared in advance, and this was input into the memory of the pickling line control unit 24. Thus, if the type of steel produced is determined, the scale thickness and pickling pattern are then determined, and after the information on the actual traveling speed is input, the distribution ratio P is determined by calculation.

Specifically, in this example, with respect to distribution ratio P, the table had set values for distribution ratio at three reference traveling speeds for each of the three types of pickling pattern. Thus, after the traveling speed was determined, the distribution ratio corresponding to the traveling speed was determined by interpolation based on the reference traveling speeds.

In the pickling line control unit 24, the overall acid supply S was calculated based on the set value of the scale thickness and the plate width and the traveling speed, and the amounts of acid solution supply S₃ and S₄ to pickling tanks 11c and 11d, respectively, were calculated as S×P and S×(1−P) using the distribution ratio P for actual control which was determined based on the traveling speed and the distribution ratio set values.

Also, in this example, this acid supply was followed by PID control, which was applied to control the flow control valves 16, 16 for the third tank acid solution supply system 12c and the final tank acid solution supply system 12d based on the continuously measured values from the continuous acid concentration measuring devices 13c and 13d so that the acid concentration of the pickling solution in each of the third tank 11c and the final tank 11d became 12%. Thus, PID control was added to the above-described feedforward control value.

As a result, the range of variation in acid concentration relative to the target concentration in each of the third tank 11c and the final tank 11d was −3.23% to +3.60% in the comparative example using only feedback control. In contrast, it was −1.5% to +1.9% in the example of the present invention in which the continuously measured values from the continuous acid concentration measuring devices 13c and 13d were not employed and only feedforward control was used, and it was improved to −0.4% to +0.5% when the continuously measured values from the continuous acid concentration measuring devices 13c and 13d were also used. From these results, it can be seen that according to this example, it is effective to employ not only feedforward control but to also employ feedback control.

Furthermore, this example was performed by arranging such that the values set in the table which are input to the memory of the pickling line control unit 24 could be automatically corrected. Namely, in S12 of FIG. 5, the total acid supply to the third tank 11c and the final tank 11d are made ALL₃ and ALL₄, and the value of t which is calculated by the equation: t=(ALL₃+ALL₄)/[A·W·(L/S)] was input to the memory of the pickling line control unit 24 as a new scale thickness. At this time, in order to suppress abrupt variations in the acid supply by feedforward control, if the value of t before rewriting is t₀, the value after rewriting is t₁, and the value of t which is calculated by the above equation is t′, then the new value for the scale thickness expressed by t₁=t₀+Rₜ×(t₀−t′) was input to the table. Rₜ is a constant less than or equal to 1.

The distribution ratio P for the traveling speed at this time was found by the equation: P=ALL₃/(ALL₃+ALL₄), and a set value for the distribution ratio P at a reference traveling speed which was higher than the traveling speed at this time was found by extrapolation, and it was input into the memory of the pickling line control unit 24. At this time, in a similar manner as for the scale thickness, in order to suppress abrupt variations, if the value of P before rewriting is P₀, the value after rewriting is P₁, and the value of P which is calculated by the above equation is P′, then a new value for the distribution ratio expressed by P₁=P₀+Rₚ×(P₀−P′) was input to the table. As in the above, Rₚ is a constant less than or equal to 1.

As a result, the range of variation in acid concentration relative to the target concentration in each of the third tank 11c and the final tank 11d was markedly improved to −0.2% to +0.2%.

### Industrial Applicability

With a continuous pickling method and continuous pickling apparatus according to the present invention, the acid concentration of pickling solution in each pickling tank can be increased and made to approach a target value while minimizing evaporation of the pickling solution from each pickling tank. As a result, a continuous pickling method and continuous pickling apparatus which can improve the productivity of pickling can be provided while minimizing alterations of existing continuous pickling equipment.

The above description of an embodiment and examples was made with respect to a continuous pickling apparatus having four pickling tanks. However, the present invention is not limited to this case, and it may be applied in the same manner to a continuous pickling apparatus having a plurality of pickling tanks or a continuous pickling apparatus having a spare tank.

Also the description of the embodiment and examples was made with respect to an example of the case in which the acid consumption of pickling solution in the third tank and the final tank is estimated and an acid solution is supplied to these pickling tanks. However, this invention is not limited to this case, and the acid consumption of pickling solution in pickling tanks other than the third tank and the final tank may also be estimated, and an acid solution may also be supplied to these pickling tanks. As a result, the acid concentration of pickling solution in each of the pickling tanks can be controlled with an even higher accuracy.

The description of the embodiment and examples was made with respect to a case using a continuous acid concentration measuring device as disclosed in JP P2000-313978A and JP P2000-313979A as an example. However, such a device is merely an example of continuous acid concentration measuring devices, and the present invention is not limited to such a continuous acid concentration measuring device. In the present invention, any acid concentration measuring device which can measure the acid concentration of pickling solution in the pickling tanks can be applied in the same manner instead of the continuous acid concentration measuring device.

In the description of the embodiment and examples, a continuous pickling apparatus was employed in which an acid solution is supplied to at least the final tank. However, the present invention is not limited to this case, and it can also be applied in the same manner to a continuous pickling apparatus in which the final tank is not supplied an acid solution.

In the description of the embodiment and examples, a continuous pickling apparatus of the type in which pickling solution in a pickling tank on the downstream side is made to successively overflow to an adjacent pickling tank on the upstream side was used. However, the present invention is not limited to this case, and it may be applied in the same manner to any continuous pickling apparatus having a plurality of tanks. For example, it can be applied in the same manner to a continuous pickling apparatus of the type as shown in FIG. 5 in which pickling solution in a pickling tank on the downstream side is successively transported to an adjacent pickling tank on the upstream side.

The scale thickness which was used was a value selected from a previously set table. However, the present invention is not limited thereto, and it may also use a value actually measured on the entry side of a pickling line by a highly accurate method such as X-ray diffractometry.

The distribution ratio was found by interpolation from table values for distribution ratio corresponding to three reference traveling speeds. However, the present invention is not limited thereto, and it may be found as a function of the traveling speed, or as a function of the steel type and the traveling speed.

In addition, the description of the embodiment and examples was made of an example of the case in which the acid solution is a hydrochloric acid solution. However, the present invention is not limited to this case, and it may be equally applied to any acid solution which can serve to pickle a steel strip, such as a sulfuric acid solution.

1. A continuous pickling method comprising performing pickling of a traveling steel strip while supplying an acid solution to at least two pickling tanks of a plurality of pickling tanks making up a continuous pickling apparatus, characterized n that
a total amount of acid solution to be supplied is determined based on a scale thickness, width and traveling speed of the steel strip, and
a distribution ratio of the acid solution supply for each of the at least two pickling tanks is determined based on a pickling pattern for the steel strip and the traveling speed of the steel strip,
thereby controlling the amount of acid solution which is supplied to each of the at least two pickling tanks.

2. A continuous pickling method as set forth in claim 1, characterized in that the distribution ratio of the acid solution supply is determined using a value selected from a plurality of predetermined set values.

3. A continuous pickling method as set forth in claim 1 or claim 2, characterized in that the value for the scale thickness is selected from a plurality of set values which are previously determined based on the steel type of the steel strip.

4. A continuous pickling method as set forth in claim 1 or claim 2, characterized in that the distribution ratio of the acid solution supply is determined using a value selected from a plurality of predetermined set values based on the traveling speed of the steel strip.

5. A continuous pickling method comprising performing pickling of a traveling steel strip while supplying an acid solution to at least two pickling tanks of a plurality of pickling tanks making up a continuous pickling apparatus, characterized in that
a total amount of acid solution to be supplied is determined based on a scale thickness, width and traveling speed of the steel strip, and a distribution ratio of the acid solution supply for the at least two pickling tanks is determined based on a pickling pattern of the steel strip and the traveling speed of the steel strip, thereby controlling the amount of acid solution which is supplied to each of the at least two pickling tanks, and
a correction value based on the deviation of a measured value of the concentration of the pickling solution in each of the at least two pickling tanks from a set value is added to the supply amount of acid solution.

6. A continuous pickling method as set forth in claim 5, wherein the predetermined set value for the scale thickness and/or for the distribution ratio of the acid solution supply is corrected and set based on a correction value of control which is obtained by addition with respect to the supply of the pickling solution.

7. A continuous pickling method as set forth in claim 1 or claim 5, wherein the at least two pickling tanks include at least a final pickling tank.

8. A continuous pickling apparatus for performing pickling of a traveling steel strip while supplying an acid solution to at least two pickling tanks of a plurality of pickling tanks making up a continuous pickling apparatus, characterized in that a total amount of acid solution to be supplied is determined based on a scale thickness, width and traveling speed of the steel strip, and a distribution ratio of the acid solution supply to the at least two pickling tanks is determined based on a pickling pattern of the steel strip and the traveling speed of the steel strip, thereby controlling the amount of acid solution which is supplied to each of the at least two pickling tanks.

9. A continuous pickling apparatus as set forth in claim 8, characterized in that the distribution ratio of the acid solution supply is determined using a value selected from a plurality of predetermined set values.

10. A continuous pickling apparatus as set forth in claim 8 or claim 9, characterized in that the value for the scale thickness is selected from a plurality of set values which are previously determined based on the steel type of the steel strip.

11. A continuous pickling apparatus as set forth in claim 8 or claim 9, characterized in that the distribution ratio of the acid solution supply is determined using a value selected from a plurality of predetermined set values based on the traveling speed of the steel strip.

12. A continuous pickling apparatus for performing pickling of a traveling steel strip while supplying an acid solution to at least two pickling tanks of a plurality of pickling tanks making up a continuous pickling apparatus, characterized in that
a total amount of acid solution to be supplied is determined based on a scale thickness, width and traveling speed of the steel strip, and a distribution ratio of the acid solution supply for the at least two pickling tanks is determined based on a pickling pattern of the steel strip and the traveling speed of the steel strip, thereby controlling the amount of acid solution which is supplied to each of the at least two pickling tanks, and
a correction value based on the deviation of a measured value of the concentration of the pickling solution in each of the at least two pickling tanks from a set value is added to the supply amount of acid solution.

13. A continuous pickling apparatus as set forth in claim 12, wherein the predetermined set value for the scale thickness and/or for the distribution ratio of the acid solution supply is corrected and set based on a correction value of control which is obtained by addition with respect to the supply of the pickling solution.

14. A continuous pickling apparatus as set forth in claim 8 or claim 11, wherein the at least two pickling tanks include at least a final pickling tank.
